(19) United States
(12) Patent Application Publication
(10) Pub. No.: US 2015/0189321 A1
(43) Pub. Date: Jul. 2, 2015

(54) Method of Binarization and Context Adaptive Binary Arithmetic Coding of Depth Coding Syntax

(71) Applicant: MEDIATEK INC., Hsin-Chu (TW)

(72) Inventors: Yi-Wen Chen, Taichung (TW); Jian-Liang Lin, Yilan County (TW); Tzu-Der Chuang, Hsinchu County (TW); Yu-Lin Chang, Taipei (TW)

(73) Assignee: MEDIATEK INC.

(21) Appl. No.: 14/538,200

(22) Filed: Nov. 11, 2014

Related U.S. Application Data
(60) Provisional application No. 61/922,901, filed on Jan. 2, 2014.

(51) Int. Cl. H04N 19/597; H04N 19/13; H04N 19/176; H04N 19/70; H04N 19/139

(52) U.S. Cl. CPC H04N 19/597; H04N 19/70; H04N 19/139; H04N 19/176; H04N 19/13

(57) ABSTRACT

A method for improved binarization and entropy coding process of syntax related to depth coding is disclosed. In one embodiment, a first value associated with the current depth block is bypass coded, where the first value corresponds to the residual magnitude of a block coded by an Intra or Inter SDC mode, the delta magnitude of a block coded by a DMM mode, or a residual sign of a block coded by the Inter SDC mode. In another embodiment, a first bin of a binary codeword is coded using arithmetic coding and the rest bins of the binary codeword are coded using bypass coding. The codeword corresponds to the residual magnitude of a block coded by the Intra or Inter SDC mode, or the delta DC magnitude of a block coded by the DMM mode.

### CROSS REFERENCE TO RELATED APPLICATIONS

The present invention is a continuation-in-part of and claims priority to U.S. Provisional Patent Application, Ser. No. 61/922,901, filed on Jan. 2, 2014, entitled “Binarization and Context Adaptive Binary Arithmetic Coding (CABAC) of the Syntax Related to Depth Coding”. The U.S. Provisional Patent Application is hereby incorporated by reference in its entirety.

### FIELD OF THE INVENTION

The present invention relates to depth coding in a three-dimensional and multi-view video coding system. In particular, the present invention relates to binarization and context adaptive binary arithmetic coding (CABAC) of depth coding syntax.

BACKGROUND AND RELATED ART

Three-dimensional (3D) television has been a technology trend in recent years that is targeted to bring viewers sensational viewing experience. Multi-view video is a technique to capture and render 3D video. The multi-view video is typically created by capturing a scene using multiple cameras simultaneously, where the multiple cameras are properly located so that each camera captures the scene from one viewpoint. The multi-view video with a large number of video sequences associated with the views represents a massive amount data. Accordingly, the multi-view video will require a large storage space to store and/or a high bandwidth to transmit. Therefore, multi-view video coding techniques have been developed in the field to reduce the required storage space and the transmission bandwidth. In three-dimensional and multi-view coding systems, the texture data as well as depth data are coded.

The Segment-wise Depth Coding (SDC), which is also referred as Simplified Depth Coding, is an alternative residual coding mode in three-dimensional coding draft based on HEVC (High Efficiency Video Coding). In current 3D-HEVC, SDC approach is employed in both Intra-prediction and Inter-prediction for depth coding. Depth Modeling Mode (DMM) is an alternative prediction mode to the depth coding in 3D-HEVC, which divides current block into two segments. Each segment may derive its own DC (Direct Current) predictor and a delta DC value corresponding to the difference between the DC and the predictor for each segment is transmitted for each segment to reconstruct the DC value. The DC value is also called CPV (Constant Partition Value) for a segment of the depth block according to some documents related to 3D-HEVC. After the DC for each segment is derived, the residual is transmitted using residual quad-tree (RQT). The residual is then added to reconstruct the segment.

FIG. 1 illustrates an example of the SDC prediction approach for the DC mode. The neighboring reconstructed depth values (112) of the current depth block (110) are used as reference samples to form the prediction samples for the current block. The average is derived from the prediction values. In order to reduce the number of prediction samples involved in averaging, the sub-sampling method is used that retains one out of four adjacent samples (120). A prediction value P is then derived for the block (130) to be coded or decoded. For decoding, the derived prediction value is added to the residue received to form the reconstructed block (140).

FIG. 2 illustrates an example of the SDC prediction approach for the DMM-1 mode, where the depth block is partitioned into two segments according to depth modeling mode. However, instead of using residual quadtree, SDC prediction approach is used in each of the segments. As shown in FIG. 2, the neighboring reconstructed samples (212) of the current depth block (210) are used to form prediction. A subsamples prediction block (220) is used for prediction. The average values (P0 and P1) for each segment is derived to form the prediction block (230). For decoding, respective residues (R0 and R1) are received and added to corresponding prediction values to form the reconstructed block (240) as shown in FIG. 2.

Depth Intra Coding

For an Intra-coded depth CU (coding unit), the depth block can be Intra-predicted by a conventional Intra mode (35 Intra prediction modes in HEVC) or Depth Modeling Mode 1 (DMM1) as specified in JCT3V-E1005 (Zhang et al., 3D-HEVC Test Model 5, Joint Collaborative Team on 3D Video Coding Extension Development of ITU-T SG16 WP3 and ISO/IEC JTC1/SC29/WG11, 5th Meeting: Vienna, AT, 27 Jul.-2 Aug. 2013, Document: JCT3V-E1005). The residual can be selectively coded using the conventional residual quadtree (RQT) structure as specified in HEVC or using the Simplified Depth Coding (SDC), which only codes one residual value for each segment within the CU instead of coding the quantized transform coefficients.

Residual Coding for DMM and SDC

To code the residual or the DC for the segments (one or two segments) within the Intra SDC coded or DMM coded PU, a residual flag depth_dc_flag (also termed as significance flag) is first transmitted to indicate whether there is any residual or delta DC signal for the segments. If any segment within the Intra SDC or DMM PU has residual/DC, a sign flag is then transmitted along with a syntax element to indicate the absolute value of the residual or delta DC for each segment. The decoder can reconstruct the residual or delta DC value based on the sign flag and the magnitude (i.e., absolute value) of the residual or delta DC.

The binarization for the syntax element of sign flag uses Fixed-length (FL) coding with maximum value equal to 1. In other words, the sign flag is binarized using only one bin as “0” or “1” to indicate the sign of the residual or delta DC value. An example of the FL binarization process according to 3D-HEVC is illustrated in Table 1.

TABLE 1
Fixed-length (FL) binarization process

Inputs: a request for a FL binarization for a syntax element and
cMax, where cMax represents the maximum value of the syntax eloement.
Output: the FL binarization of the syntax element.
FL binarization is constructed by using an unsigned integer bin string of the syntax element value, where the bit length of the bin string, fixedLength is determined according to fixedLength = Ceil(Log2(cMax + 1)). The indexing of bins for the FL binarization is such that the binIdx = 0 relates to the most significant bit with increasing values of binIdx towards the least significant bit.

The binary codeword of the syntax element for the absolute residual or delta DC value can be divided into a prefix codeword and a suffix codeword. The binarization process for the prefix codeword uses the truncated unary (TU) codeword assignment and the value 13 is viewed as an escape code. The codeword for any value larger than 13 is appended with a suffix codeword generated by the unsigned 0-th order Exp-Golomb (UEGO) binarization process. The process to generate k-th order Exp-Golomb (EGk) binary code is described in Table 2.

TABLE 2
k-th order Exp-Golomb (EGk) binarization process

```
Inputs: a request for an EGk binarization for a syntax element.
Output: the EGk binarization of the syntax element.
The bin string of the EGk binarization process of a
syntax element synVal is specified as follows,
where each call of the function put( X ), X = 0 or 1,
adds the binary value X at the end of the bin string:
  absV = Abs( synVal )
  stopLoop = 0
  do {
  if( absV >= ( 1 << k ) ) {
    put( 1 )
    absV = absV − ( 1 << k)
    k++
  } else {
    put( 0 )
    while( k− − )
      put( ( absV >> k) & 1 )
    stopLoop = 1
  }
} while( !stopLoop )
```

An example of binary codeword for the absolute residual value is illustrated in Table 3. When the CU has only one segment and the absolute residual or delta DC value is equal to zero, there is no need to transmit the absolute residual or delta DC value. Accordingly, the codeword table is designed with binary codewords for the absolute value minus one. When there are two segments within the CU, the zero residual or delta DC still needs to be signaled. In this case, the binary codeword is designed for the absolute value starting from zero. In the example of Table 3, there are 16 values (i.e., 0 to 15) to be coded. For values 0 through 12, unary codes with code lengths from 1 through 13 are used without suffix. For values 13 through 15, the prefix part corresponds to 13 consecutive 1's and the suffix part corresponds to 0-th order Exp-Golomb (UEGO), where the corresponding suffixes are “0”, “100” and “101” respectively.

TABLE 3

| inter_sdc_resi_abs_minus1 | Prefix | Suffix |
|---|---|---|
| 0 | 0 | — |
| 1 | 10 | — |
| 2 | 110 | — |
| 3 | 1110 | — |
| . . . | . . . | — |
| 12 | 1111111111110 | — |
| 13 | 1111111111111 | 0 |
| 14 | 1111111111111 | 100 |
| 15 | 1111111111111 | 101 |

In current 3D-HEVC Test Model version 9.0 (HTM-9.0), the Intra residual flag (i.e., depth_dc_flag) is CABAC coded with two context models as shown in Table 4, where the context model is selected according to the number of segments. The residual sign flag (i.e., depth_dc_sign_flag) is bypass coded. The bypass coding simply skips the whole regular context-based adaptive binary arithmetic coding (CABAC) process. The prefix-codeword of the absolute residual values (i.e., depth_dc_abs) is CABAC coded and the suffix-codeword of the absolute residual value is bypass coded.

TABLE 4

if( DmmFlag[x0][y0] | | SdcFlag[x0][y0] ) {

dcNumSeg = ( DepthIntraMode[x0][y0] = =

INTRA_DEP_SDC_PLANAR ) ? 1 : 2

| | |
|---|---|
| depth_dc_flag[x0][y0] | ae(v) |
| if ( depth_dc_flag[x0][y0] ) | |
| for( i = 0; i < dcNumSeg; i ++ ) { | |

| | |
|---|---|
| depth_dc_abs[x0][y0][i] | ae(v) |
| if ( depth_dc_abs[x0][y0][i]) | |

| | |
|---|---|
| depth_dc_sign_flag[x0][y0][i] | ae(v) |

}

}

Syntax element DmmFlag[x0][y0] indicates whether depth block at (x0,y0) is DMM coded, syntax element SdcFlag[x0][y0]] indicates whether depth block at (x0,y0) is SDC coded, and syntax element dcNumSeg indicates the number of segments for the depth block. Furthermore, syntax elements depth_dc_flag[x0][y0] indicates whether there is any residual or delta DC signal for the segments for the depth block at (x0,y0). If there is any residual or delta DC signal for the segments, the absolute value and sign of the residual or delta DC signal is transmitted.

Inter Depth Coding

The Inter SDC encodes only one residual for each PU of non-skipped inter-coded depth CU. For each PU, the difference between the average value of original signal and the average value of prediction signal is used as the residual (without quantization) for all pixels in the PU. The residual is signaled to the decoder. In the current 3D-HEVC, the depth look-up table is not used for inter-SDC mode.

Encoder will perform additional rate distortion optimized selection between the conventional Inter modes in 3D-HEVC and the inter-SDC modes. When the current CU is coded as a non-skipped inter-coded depth CU, one CU-level flag (i.e., inter-SDC flag) will be encoded to indicate either conventional Inter mode or inter-SDC mode is used.

To avoid possible overlap between inter-SDC mode and the skip mode, inter-SDC is only applied when residual of any PU in a CU is non-zero, which means that the inter-SDC flag is only needed to be transmitted when the current CU is not a skipped CU.

Residual Coding for Inter SDC

To code the residual for each Inter SDC coded PU, a sign flag is transmitted along with a syntax element to indicate the absolute value of the residual. The decoder can reconstruct the residual value based on the sign flag and the absolute value of the residual. The binarization for the syntax element of sign flag is based on fixed-length (FL) coding with maximum value equal to 1. In other words, the sign flag is binarized using only one bin as “0” or “1” to indicate the sign of the residual value. The binary codeword of the syntax element for the absolute value can be divided into the prefix codeword and the suffix codeword. The binarization for the prefix codeword uses the truncated unary (TU) codeword assignment and the value 13 is viewed as an escape code. The codeword for any value larger than 13 will be appended with a suffix codeword generated by the unsigned 0-th order Exp-Golomb (UEGO) binarization process. Since there is no need to transmit the absolute residual value when the absolute value is equal to zero, the binary codeword is designed for the absolute value minus one. In the current 3D-HEVC Test Model version 9.0 (HTM-9.0), the Inter SDC flag (i.e., inter_sdc_flag) is bypass coded as shown in Table 5. When inter_sdc_flag has a value of 1, it indicates that the depth block is Inter SDC coded. As shown in Table 5, syntax elements inter_sdc_resi_sign_flag and inter_sdc_resi_abs_minus1 are transmitted for each PU (prediction unit) when the depth block is Inter SDC coded. The number of PUs for the CU (coding unit) is indicated by puNum in Table 5. Each bin of the binary codeword of the residual sign flag (i.e., inter_sdc_resi_sign_flag) and the Prefix codeword (inter_sdc_resi_abs_minus1) of the absolute residual values is CABAC coded.

TABLE 5

If ( vps_inter_sdc_flag && PredMode[x0][y0] ! =

MODE_INTRA && !skip_flag[x0][y0] )

| | |
|---|---|
| inter_sdc_flag | ae(v) |

If ( inter_sdc_flag ) {

puNum = ( PartMode = = PART_2Nx2N ) ? 1 : (

PartMode = = PART_NxN ? 4 : 2 )

for( i = 0; i < puNum; i++ ) {

| | |
|---|---|
| inter_sdc_resi_abs_minus1[x0][y0][i] | ae(v) |
| inter_sdc_resi_sign_flag[x0][y0][i] | ae(v) |

}

}

As described above, the entropy coding process for Intra depth coding and Inter depth coding is different. Furthermore, the existing binarization and coding process for syntax elements related to depth coding may not be efficient. For example, when CABAC is used, the number of contexts is very limited. It is desirable to develop unified and/or improved binarization and entropy coding for Intra and Inter depth coding.

### BRIEF SUMMARY OF THE INVENTION

A method of depth coding for a depth block in a three-dimensional (3D) encoding system or a 3D decoding system is disclosed to improve the binarization and entropy coding process of syntax related to depth coding. In one embodiment of the present invention, a first value associated with the current depth block is bypass coded. The first value corresponds to the residual magnitude of the current depth block coded by an Intra SDC (Segment-wise Depth Coding) mode or an Inter SDC mode, delta DC (Direct Current) magnitude of the current block coded by a DMM (Depth Modeling Mode) mode, or a residual sign of the current depth block coded by the Inter SDC mode.

In another embodiment, a first bin of a binary codeword is coded using arithmetic coding and the rest bins of the binary codeword are coded using bypass coding, where the codeword corresponds to the residual magnitude of the current depth block coded by the Intra SDC mode or the Inter SDC mode, or the delta DC magnitude of the current block coded by a DMM mode. The first bins of the binary codewords from multiple depth blocks can be aggregated together for the arithmetic coding to improve the throughput. Similarly, the rest bins of the binary codewords from multiple depth blocks can be aggregated together for the bypass coding to improve the throughput.

In yet another embodiment, the entropy coding for the depth intra DC flag to indicate whether there is any residual or delta DC (Direct Current) signal for the current depth block when the current depth block is coded in the Intra SDC mode or the DMM mode, the Inter SDC flag to indicate whether the current depth block is coded in the Inter SDC mode, the Intra depth DC sign flag to indicate Intra residual sign of the current block when the current depth block is coded in the Intra SDC mode or the DMM mode and there is at least one residual or delta DC signal for the current depth block, and the Inter SDC sign flag to indicate Inter SDC residual sign of the current block when the current depth block is coded in the Inter SDC mode, is unified by using the bypass coding.

### BRIEF DESCRIPTION OF THE DRAWINGS

FIG. 1 illustrates the processing steps for depth block decoding based on Simplified Depth Coding (SDC) DC mode, where the depth block contains one segment.

FIG. 2 illustrates the processing steps for depth block decoding based on Simplified Depth Coding (SDC) depth modeling mode 1 (DMM-1), where the depth block is divided into two segments.

FIG. 3 illustrates an exemplary flowchart for a system incorporating improved binarization and entropy coding process of syntax related to depth coding according to an embodiment of the present invention, where the residual magnitude of the current depth block coded by an Intra SDC mode or an Inter SDC mode, the delta DC magnitude of the current block coded by a DMM mode, or the residual sign of the current depth block coded by the Inter SDC mode is coded using the bypass coding.

FIG. 4 illustrates an exemplary flowchart for an encoder system incorporating improved binarization and entropy coding process of syntax related to depth coding according to an embodiment of the present invention, where the first bin of a binary codeword is coded using arithmetic coding and the rest bins of the binary codeword are coded using bypass coding, and the codeword corresponds to the residual magnitude of the current depth block coded by the Intra SDC mode or the Inter SDC mode, or the delta DC magnitude of the current block coded by a DMM mode.

FIG. 5 illustrates an exemplary flowchart for a decoder system corresponding to the encoder system in FIG. 4.

FIG. 6 illustrates an exemplary flowchart for a system incorporating improved binarization and entropy coding process of syntax related to depth coding according to an embodiment of the present invention, where entropy coding for various flags associated with the depth coding syntax of the current depth block is unified by using bypass coding e.

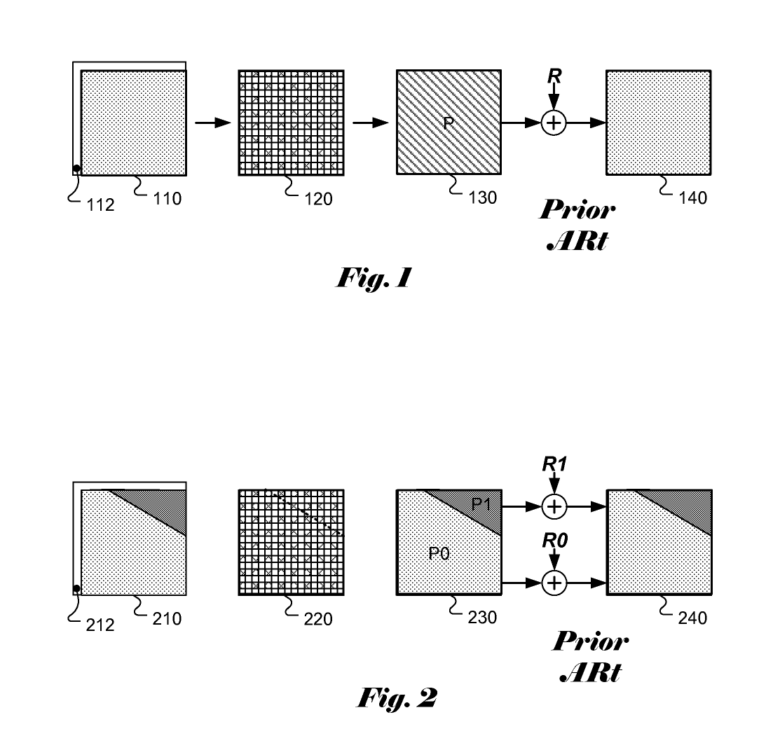

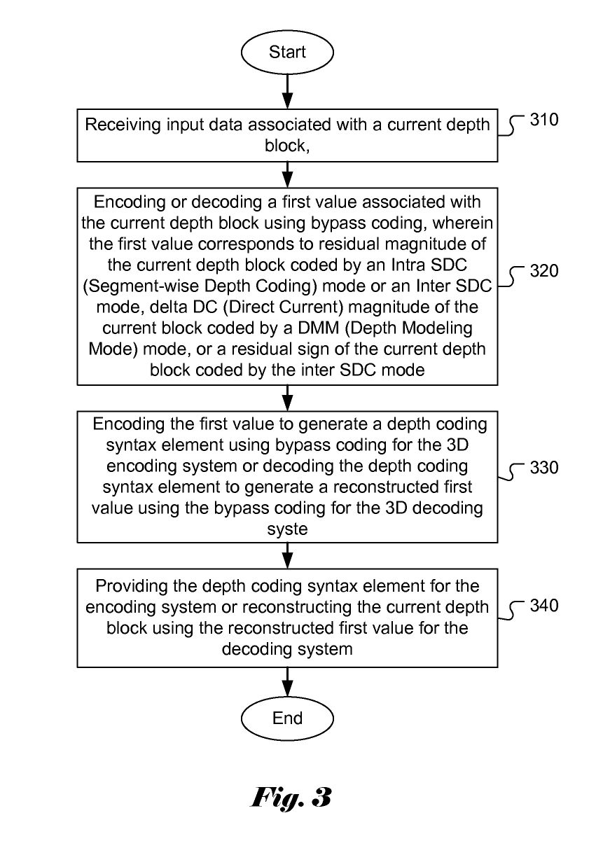

### DETAILED DESCRIPTION OF THE INVENTION

As described above, the entropy coding process for Intra depth coding and Inter depth coding is different. Furthermore, the existing binarization and coding process for syntax elements related to depth coding may not be efficient. Accordingly, the present invention discloses unified and/or improved binarization and entropy coding for Intra and Inter depth coding.

Various context modes and binarization methods for signaling the syntax related to depth residual coding are disclosed according to the present invention to improve the binarization and entropy coding process.

In the conventional 3D-HEVC system, the depth Intra DC flag (depth_dc_flag) is coded by CABAC with two context models selected according to the number of segments. In one embodiment of the present invention, the entropy coding of the depth Intra DC flag (depth_dc_flag) can be modified according to one of the following methods:
1. Bypass coding,
2. Arithmetic (for example CABAC) coding with one context,
3. Arithmetic (for example CABAC) coding with two contexts (referring to the coded Inter SDC flag of the immediate left neighbor block to select the context),
4. Arithmetic (for example CABAC) coding with three contexts (referring to the coded Inter SDC flag of the immediate left neighbor block and the immediate above neighbor block to select the context), and
5. Arithmetic (for example CABAC) coding with four contexts (referring to the CU splitting depth to select the context).

In the conventional 3D-HEVC system, the Inter SDC flag (inter_sdc_flag) is bypass coded. In one embodiment of the present invention, the entropy coding of the Inter SDC flag (inter_sdc_flag) can be modified according to one of the following methods:
1. Arithmetic (for example CABAC) coding with one context,
2. Arithmetic (for example CABAC) coding with two contexts (referring to the coded Inter SDC flag of the immediate left neighbor block to select the context),
3. Arithmetic (for example CABAC) coding with three contexts (referring to the coded Inter SDC flag of the immediate left neighbor block and the immediate above neighbor block to select the context), and
4. Arithmetic (for example CABAC) coding with four contexts (referring to the CU splitting depth to select the context).

In the conventional 3D-HEVC system, the Intra depth DC sign flag (depth_dc_sign_flag) is bypass coded. In one embodiment of the present invention, the entropy coding of the Intra depth DC sign flag (depth_dc_sign_flag) can be modified according to one of the following methods:
1. Arithmetic (for example CABAC) coding with one context,
2. Arithmetic (for example CABAC) coding with two contexts (referring to the coded Inter SDC flag of the immediate left neighbor block to select the context),
3. Arithmetic (for example CABAC) coding with three contexts (referring to the coded Inter SDC flag of the immediate left neighbor block and the immediate above neighbor block to select the context), and
4. Arithmetic (for example CABAC) coding with four contexts (referring to the CU splitting depth to select the context).

In the conventional 3D-HEVC system, each bin of the binary codeword of the Inter SDC residual sign flag (inter_sdc_resi_sign_flag) is CABAC coded. In one embodiment of the present invention, the entropy coding of the Inter SDC residual sign flag (inter_sdc_resi_sign_flag) can be modified according to one of the following methods:
1. Bypass coding,
2. Arithmetic (for example CABAC) coding with two contexts (referring to the coded Inter SDC flag of the immediate left neighbor block to select the context),
3. Arithmetic (for example CABAC) coding with three contexts (referring to the coded Inter SDC flag of the immediate left neighbor block and the immediate above neighbor block to select the context), and
4. Arithmetic (for example CABAC) coding with four contexts (referring to the CU splitting depth to select the context).

In the conventional 3D-HEVC, the depth Intra DC flag (depth_dc_flag) and Inter SDC flag (inter_sdc_flag) are coded differently (i.e., CABAC versus bypass respectively). Also, Intra depth DC sign flag (depth_dc_sign_flag) and Inter SDC sign flag (inter_sdc_resi_sign_flag) are coded differently (i.e., bypass versus CABAC respectively). In one embodiment of the present invention, the entropy coding of the depth Intra DC flag (depth_dc_flag), Inter SDC flag (inter_sdc_flag), Intra depth DC sign flag (depth_dc_sign_flag), Inter SDC residual sign flag (inter_sdc_resi_sign_flag) can all be coded according to one of the following methods:
1. Bypass coding,
2. Arithmetic (for example CABAC) coding with one context,
3. Arithmetic (for example CABAC) coding with two contexts (referring to the coded Inter SDC flag of the immediate left neighbor block to select the context),
4. Arithmetic (for example CABAC) coding with three contexts (referring to the coded Inter SDC flag of the immediate left neighbor block and the immediate above neighbor block to select the context), and
5. Arithmetic (for example CABAC) coding with four contexts (referring to the CU splitting depth to select the context).

In the conventional 3D-HEVC, the residual magnitude of Intra depth DC (depth_dc_abs) is represented by a prefix part and a suffix part, where the prefix part is CABAC coded and the suffix is bypass coded. In one embodiment of the present invention, the entropy coding of the residual magnitude of Intra depth DC (depth_dc_abs) can be modified according to one of the following methods:
1. All the bins of the binary codeword are bypass coded,
2. Only the first N bins of the binary codeword are arithmetic (for example CABAC) coded, the rest of the bins are bypass coded (N could be any positive integer, each arithmetic coded bin has its own context),
3. Only the first N bins of the binary codeword are arithmetic (for example CABAC) coded, the rest of the bins are bypass coded (N could be any positive integer, all the arithmetic coded bins share one context),
4. Only the first bin of the binary codeword are arithmetic (for example CABAC)coded, the rest of the bins are bypass coded, the first bin is arithmetic coded with 1 context,
5. Only the first bin of the binary codeword are arithmetic (for example CABAC)coded, the rest of the bins are bypass coded, the first bin is arithmetic coded with two contexts (referring to the coded Inter SDC flag of the immediate left neighbor block to select the context),
6. Only the first bin of the binary codeword are arithmetic (for example CABAC)coded, the rest of the bins are bypass coded, the first bin is arithmetic coded with three contexts (referring to the coded Inter SDC flag of the immediate left neighbor block and the immediate above neighbor block to select the context), and
7. Only the first bin of the binary codeword are arithmetic (for example CABAC)coded, the rest of the bins are bypass coded, the first bin is arithmetic coded with four contexts (referring to the CU splitting depth to select the context).

In the conventional 3D-HEVC, the residual magnitude of Inter SDC (inter_sdc_resi_abs_minus1) is represented by a prefix part and a suffix part, where the prefix part is CABAC coded and the suffix is bypass coded. In one embodiment of the present invention, the entropy coding of the residual magnitude of Inter SDC (inter_sdc_resi_abs_minus1) can be modified according to one of the following methods:
1. All the bins of the binary codeword are bypass coded,
2. Only the first N bins of the binary codeword are arithmetic (for example CABAC) coded, the rest of the bins are bypass coded (N could be any positive integer, each arithmetic coded bin has its own context),
3. Only the first N bins of the binary codeword are arithmetic (for example CABAC) coded, the rest of the bins are bypass coded (N could be any positive integer, all the arithmetic coded bins share one context),
4. Only the first bin of the binary codeword are arithmetic (for example CABAC)coded, the rest of the bins are bypass coded, where the first bin is arithmetic coded with 1 context,
5. Only the first bin of the binary codeword are arithmetic (for example CABAC)coded, the rest of the bins are bypass coded, where the first bin is arithmetic coded with two contexts (referring to the coded Inter SDC flag of the immediate left neighbor block to select the context),
6. Only the first bin of the binary codeword are arithmetic (for example CABAC)coded, where the rest of the bins are bypass coded, the first bin is arithmetic coded with three contexts (referring to the coded Inter SDC flag of the immediate left neighbor block and the immediate above neighbor block to select the context), and
7. Only the first bin of the binary codeword are arithmetic (for example CABAC)coded, the rest of the bins are bypass coded, where the first bin is arithmetic coded with four contexts (referring to the CU splitting depth to select the context).

In another embodiment of the present invention, the entropy coding of the residual magnitude of Intra depth DC (depth_dc_abs) and the residual magnitude of Inter SDC (inter_sdc_resi_abs_minus1) aggregates the arithmetic (for example CABAC) bins of these two syntax elements together and also aggregates the bypass coded bins together to increase the parsing throughput.

For example, as shown in Table 6, if only the first bin of DC magnitude of the Intra SDC or DMM mode is CABAC coded and the rest bins are bypass coded, the syntax can be arranged as follows to aggregate the CABAC bins together and the bypass bins together.

TABLE 6
if( DmmFlag[x0][y0] | | SdcFlag[x0][y0] ) {

dcNumSeg = ( DepthIntraMode[x0][y0] = =

INTRA_DEP_SDC_PLANAR) ? 1 : 2

| | |
|---|---|
| depth_dc_flag[x0][y0] | ae(v) |
| if ( depth_dc_flag[x0][y0] ) { | |

for( I = 0; I < dcNumSeg; I ++ ) {

| | |
|---|---|
| depth_dc_abs_1st_bin [x0][y0][I] | ae(v) |

| | |
|---|---|
| } | |
| for( I = 0; I < dcNumSeg; I ++ ) { | |
| depth_dc_abs_rest_bin [x0][y0][I] | ae(v) |

if (depth_dc_abs_1st_bin [x0][y0][I])

| | |
|---|---|
| depth_dc_sign_flag[x0][y0][I] | ae(v) |

}

}
}

In Table 6, depth_dc_abs_{—}1st_bin corresponds to the first bin of depth_dc_abs and depth_dc_abs_rest_bin corresponds to the rest bins of depth_dc_abs. In Table 2, when the block has two segments as indicated by dcNumSeg, depth_dc_abs_rest_bin and depth_dc_abs for both segments are all aggregated together. Also, depth_dc_abs_{—}1st_bin from both segments are aggregated together. Furthermore, since the first bin has been separated from other bins, the first bin can be assigned a semantic to specify whether the absolute DC value DcOffset[x0][y0][i] is greater than 0. One example of syntax and semantic modified from Table 6 is illustrated in Table 7.

TABLE 7
if( DmmFlag[x0][y0] | | SdcFlag[x0][y0] ) {

dcNumSeg = ( DepthIntraMode[x0][y0] = =

INTRA_DEP_SDC_PLANAR ) ? 1 : 2

| | |
|---|---|
| depth_dc_flag[x0][y0] | ae(v) |
| if ( depth_dc_flag[x0][y0] ) { | |

for( I = 0; I < dcNumSeg; I ++ ) {

| | |
|---|---|
| depth_dc_abs_greater0_flag [x0][y0][I] | ae(v) |

}
for( I = 0; I < dcNumSeg; I ++ ) {

| | |
|---|---|
| depth_dc_abs_minus1 [x0][y0][I] | ae(v) |
| if (depth_dc_abs_greater0_flag [x0][y0][I]) | |

| | |
|---|---|
| depth_dc_sign_flag[x0][y0][I] | ae(v) |

}

}
}

In Table 7, depth_dc_abs_{—} greater0flag [x0][y0][I] specifies whether the absolute DC value, DcOffset[x0][y0][i] is greater than 0. depth_dc_abs_minus1[x0][y0][i] and depth_dc_sign_flag[x0][y0][i] are used to derive DcOffset[x0][y0][i] as follows:

DcOffset[x0][y0][i]=(1−2*depth_dc_sign_flag[x0][y0][i])*(depth_dc_abs_minus1[x0][y0][i]+1−dcNumSeg+2). (1)

When depth_dc_abs_minus1[x0][y0][i] is not present, it is inferred to be −1. When depth_dc_sign_flag [x0][y0][i] is not present, it is inferred to be 0.

In another example, only the first bin (i.e., inter_sdc_resi_abs_minus1_{—}1st_bin) of inter_sdc_resi_abs_minus1 is CABAC coded. The rest bins and the Inter SDC residual sign (inter_sdc_resi_sign_flag) are bypass code. The syntax can be arranged as shown in Table 8 to aggregate the CABAC bins together and the bypass bins together.

TABLE 8
if( vps_inter_sdc_flag && PredMode[x0][y0] ! =

MODE_INTRA && !skip_flag[x0][y0] )

| | |
|---|---|
| inter_sdc_flag | ae(v) |

if( inter_sdc_flag ) {

puNum = ( PartMode = = PART_2Nx2N ) ? 1 : (

PartMode = = PART_NxN ? 4 : 2 )

for( i = 0; i < puNum; i++ ) {

| | |
|---|---|
| inter_sdc_resi_abs_minus1_1st_bin[x0][y0][i] | ae(v) |

}

for( i = 0; i < puNum; i++ ) {

| | |
|---|---|
| inter_sdc_resi_abs_minus1_rest_bin [x0][y0][i] | ae(v) |
| inter_sdc_resi_sign_flag[x0][y0][i] | ae(v) |

}

}

}

The aggregation of arithmetic (for example CABAC) bins and bypass bins is expected to improve the parsing throughput of an entropy coder. It may be applied in other cases where some bins of the residual or delta DV syntax are arithmetic coded and other bins are bypass coded. The aggregation of arithmetic bins and bypass bins is not limited to the examples shown above.

In another example, the residual magnitude of Inter SDC mode (i.e., inter_sdc_resi_abs) is coded starting from 0 instead of 1 as shown in Tables 9 and 10.

TABLE 9
if( vps_inter_sdc_flag && PredMode[x0][y0] ! =

MODE_INTRA && !skip_flag[x0][y0] )

| | |
|---|---|
| inter_sdc_flag | ae(v) |

if( inter_sdc_flag ) {

puNum = ( PartMode = = PART_2Nx2N ) ? 1 : (

PartMode = = PART_NxN ? 4 : 2 )

for( i = 0; i < puNum; i++ ) {

| | |
|---|---|
| inter_sdc_resi_abs [x0][y0][i] | ae(v) |
| inter_sdc_resi_sign_flag[x0][y0][i] | ae(v) |

}

}

In Table 9, inter_sdc_resi_abs and inter_sdc_resi_sign_flag for all PUs (prediction units) within a CU (coding unit) are aggregated together. The number of PUs within the CU is indicated by puNum. Furthermore, syntax elements inter_sdc_resi_abs[x0][y0][i] and inter_sdc_resi_sign_flag[x0][y0][i] are used to derive InterSdcResi[x0][y0][i] as follows:

InterSdcResi[x0][y0][i]=(1−2*inter_sdc_resi_sign_flag[x0][y0][i])*(inter_sdc_resi_abs[x0][y0][i]) (2)

TABLE 10

if( vps_inter_sdc_flag && PredMode[x0][y0] ! =

MODE_INTRA && !skip_flag[x0][y0] )

| | |
|---|---|
| inter_sdc_flag | ae(v) |

if( inter_sdc_flag ) {

puNum = ( PartMode = = PART_2Nx2N ) ? 1 : (

PartMode = = PART_NxN ? 4 : 2 )

for( i = 0; i < puNum; i++ ) {

| | |
|---|---|
| inter_sdc_resi_abs_1st_bin[x0][y0][i] | ae(v) |

}

for( i = 0; i < puNum; i++ ) {

| | |
|---|---|
| inter_sdc_resi_abs_rest_bin [x0][y0][i] | ae(v) |
| inter_sdc_resi_sign_flag[x0][y0][i] | ae(v) |

}

}

}

In Table 10, syntax element inter_sdc_resi_abs_{—}1st_bin [x0][y0][i] corresponds to the first bit of Inter SDC residual magnitude. inter_sdc_resi_abs_rest_bin [x0][y0][i] and inter_sdc_resi_sign_flag [x0][y0][i] are used to derive InterSdcResi [x0][y0][i] as follows:

InterSdcResi[x0][y0][i]=(1−2*inter_sdc_resi_sign_flag [x0][y0][i])*(inter_{—}sdc_resi_abs[x0][y0][i]) (3)

Where inter_sdc_resi_abs[x0][y0][i] is the variable of aggregating the inter_sdc_resi_abs_{—}1st_bin [x0][y0][i] and inter_sdc_resi_abs_rest_bin.

When inter_sdc_resi_abs_rest_bin [x0][y0][i] is not present, it is inferred to be −1. When inter_sdc_resi_sign_flag [x0][y0][i] is not present, it is inferred to be 0.

FIG. 3 illustrates an exemplary flowchart for a system incorporating improved binarization and entropy coding process of syntax related to depth coding according to an embodiment of the present invention. The system receives input data associated with a current depth block as shown in step 310. The current depth block may correspond to a depth CU (coding unit) or a depth PU (prediction unit). The depth block is partitioned into one or more segments. For encoding, the input data associated with the depth block corresponds to the depth samples to be coded. For decoding, the input data associated with the current depth block corresponds to the coded depth data to be decoded. The input data associated with the current depth block may be retrieved from memory (e.g., computer memory, buffer (RAM or DRAM) or other media) or from a processor. A flag is encoded or decoded to indicate whether a first value associated with the current depth block is bypass coded in step 320. The first value corresponds to the residual magnitude of the current depth block coded by an Intra SDC (Segment-wise Depth Coding) mode or an Inter SDC mode, delta DC (Direct Current) magnitude of the current block coded by a DMM (Depth Modeling Mode) mode, or a residual sign of the current depth block coded by the inter SDC mode. If the flag indicates that first value is bypass coded, the first value is encoded to generate a depth coding syntax element using bypass coding for the 3D encoding system or the depth coding syntax element is decoded to generate a reconstructed first value using the bypass coding for the 3D decoding system as shown in step 330. If the flag indicates that first value is bypass coded, in the encoding system, the depth coding syntax element is provided or in the decoding system, the current depth block is reconstructed using the reconstructed first value in step 340.

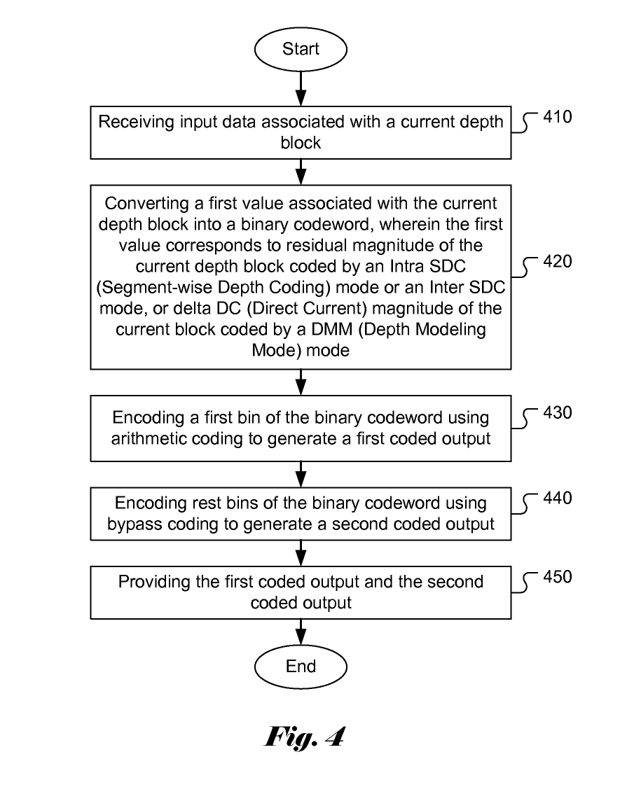

FIG. 4 illustrates an exemplary flowchart for an encoder system incorporating improved binarization and entropy coding process of syntax related to depth coding according to an embodiment of the present invention, where the first bin of a binary codeword is coded using arithmetic coding and the rest bins of the binary codeword are coded using bypass coding. Input data associated with a current depth block is received in step 410. A first value associated with the current depth block is converted into a binary codeword in step 420. The first value corresponds to the residual magnitude of the current depth block coded by an Intra SDC (Segment-wise Depth Coding) mode or an Inter SDC mode, or delta DC (Direct Current) magnitude of the current block coded by a DMM (Depth Modeling Mode) mode. A first bin of the binary codeword is encoded using arithmetic (for example CABAC, Context Adaptive Binary Arithmetic Coding) coding to generate a first coded output as shown in step 430. The rest bins of the binary codeword are coded using bypass coding to generate a second coded output in step 440. The first coded output and the second coded output are then provided as part of coded data for the current depth block in step 450.

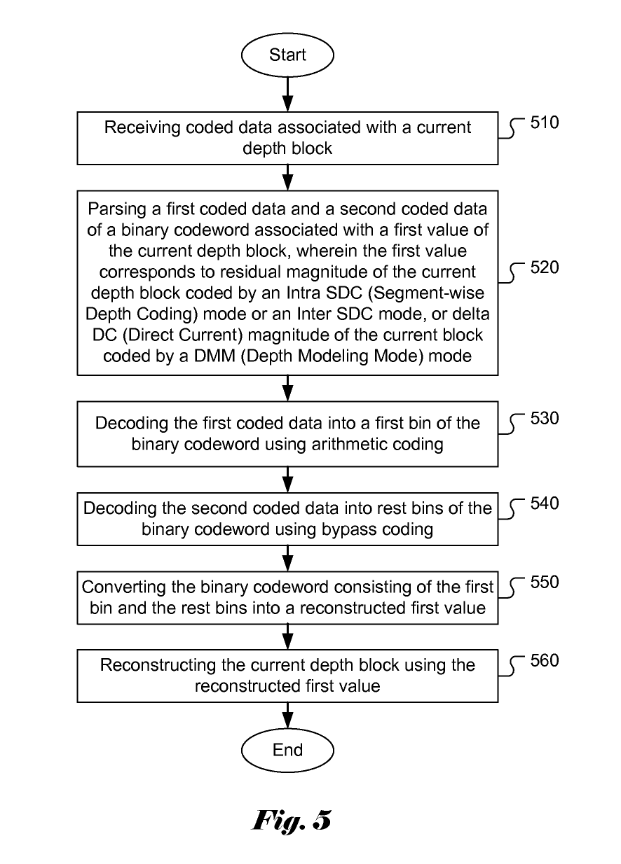

FIG. 5 illustrates an exemplary flowchart for a decoder system incorporating improved binarization and entropy coding process of syntax related to depth coding according to an embodiment of the present invention, where the first bin of a binary codeword is coded using arithmetic coding and the rest bins of the binary codeword are coded using bypass coding. Coded data associated with a current depth block is received in step 510. A first coded data and a second coded data of a binary codeword associated with a first value of the current depth block are parsed in step 520. The first value corresponds to the residual magnitude of the current depth block coded by an Intra SDC (Segment-wise Depth Coding) mode or an Inter SDC mode, or delta DC (Direct Current) magnitude of the current block coded by a DMM (Depth Modeling Mode) mode. The first coded data is decoded into a first bin of the binary codeword using arithmetic (for example CABAC, Context Adaptive Binary Arithmetic Coding) coding in step 530. The second coded data is decoded into rest bins of the binary codeword using bypass coding in step 540. The binary codeword consisting of the first bin and the rest bins is converted into a reconstructed first value in step 550. The current depth block is reconstructed using the reconstructed first value in step 560.

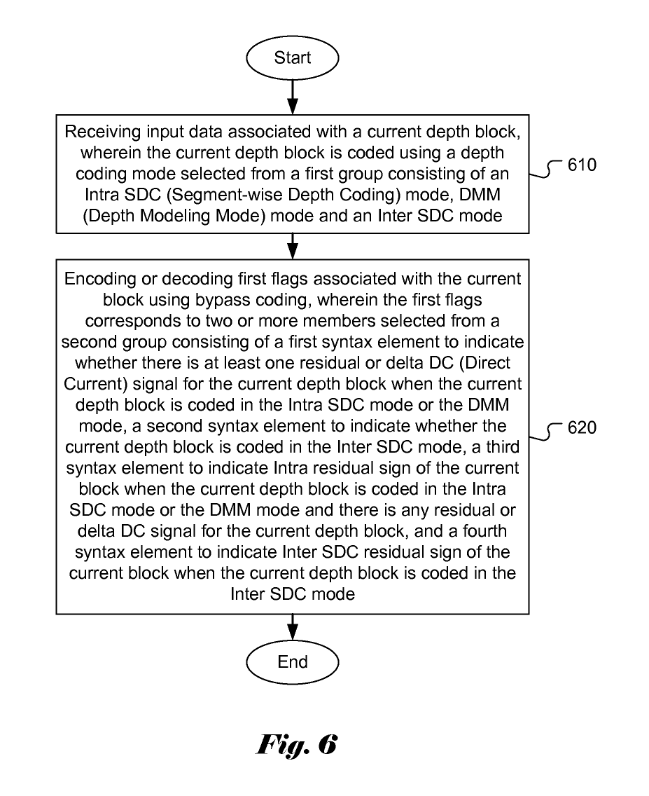

FIG. 6 illustrates an exemplary flowchart for a system incorporating improved binarization and entropy coding process of syntax related to depth coding according to an embodiment of the present invention, where entropy coding for various flags associated with the depth coding syntax of the current depth block is unified by using bypass coding. Input data associated with a current depth block is received in step 610, where the current depth block is coded using a depth coding mode selected a group consisting of an Intra SDC (Segment-wise Depth Coding) mode, DMM (Depth Modeling Mode) mode and an Inter SDC mode. First flags associated with the current block are encoded or decoded using bypass coding in step 620. The first flags corresponds to two or more members selected from a second group consisting of:
1. a first syntax element to indicate whether there is at least one residual or delta DC (Direct Current) signal for the current depth block when the current depth block is coded in the Intra SDC mode or the DMM mode,
2. a second syntax element to indicate whether the current depth block is coded in the Inter SDC mode,
3. a third syntax element to indicate Intra residual sign of the current block when the current depth block is coded in the Intra SDC mode or the DMM mode and there is any residual or delta DC signal for the current depth block, and
4. a fourth syntax element to indicate Inter SDC residual sign of the current block when the current depth block is coded in the Inter SDC mode

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of depth coding for a depth block in a three-dimensional (3D) encoding system or a 3D decoding system, the method comprising:
receiving input data associated with a current depth block;
encoding or decoding a first value associated with the current depth block using bypass coding, wherein the first value corresponds to residual magnitude of the current depth block coded by an Intra SDC (Segment-wise Depth Coding) mode or an Inter SDC mode, delta DC (Direct Current) magnitude of the current block coded by a DMM (Depth Modeling Mode) mode, or a residual sign of the current depth block coded by the inter SDC mode;
encoding the first value to generate a depth coding syntax element using bypass coding for the 3D encoding system or decoding the depth coding syntax element to generate a reconstructed first value using the bypass coding for the 3D decoding system; and
providing the depth coding syntax element for the encoding system or reconstructing the current depth block using the reconstructed first value for the decoding system.

2. A method of depth coding for a depth block in a three-dimensional (3D) encoding system, the method comprising:
receiving input data associated with a current depth block;
converting a first value associated with the current depth block into a binary codeword, wherein the first value corresponds to residual magnitude of the current depth block coded by an Intra SDC (Segment-wise Depth Coding) mode or an Inter SDC mode, or delta DC (Direct Current) magnitude of the current block coded by a DMM (Depth Modeling Mode) mode;
encoding a first bin of the binary codeword using arithmetic coding to generate a first coded output;
encoding rest bins of the binary codeword using bypass coding to generate a second coded output; and
providing the first coded output and the second coded output.

3. The method of claim 2, further comprising aggregating arithmetic bins from the current depth block together for the arithmetic coding, wherein the arithmetic bins correspond to one or more arithmetic coded bins of one or more codewords associated with the current depth block and the arithmetic bins include the first bin of the binary codeword.

4. The method of claim 2, further comprising aggregating bypass bins from the current depth block together for the bypass coding, wherein the bypass bins correspond to one or more bypass coded bins of one or more codewords associated with the current depth block and the bypass bins include the rest bins of the binary codewords.

5. A method of depth coding for a depth block in a three-dimensional (3D) decoding system, the method comprising:
receiving coded data associated with a current depth block;
parsing a first coded data and a second coded data of a binary codeword associated with a first value of the current depth block, wherein the first value corresponds to residual magnitude of the current depth block coded by an Intra SDC (Segment-wise Depth Coding) mode or an Inter SDC mode, or delta DC (Direct Current) magnitude of the current block coded by a DMM (Depth Modeling Mode) mode;
decoding the first coded data into a first bin of the binary codeword using arithmetic coding;
decoding the second coded data into rest bins of the binary codeword using bypass coding;
converting the binary codeword consisting of the first bin and the rest bins into a reconstructed first value; and
reconstructing the current depth block using the reconstructed first value.

6. The method of claim 5, further comprising aggregating arithmetic bins from the current depth block together for the arithmetic coding, wherein the arithmetic bins correspond to one or more arithmetic coded bins of one or more codewords associated with the current depth block and the arithmetic bins include the first bin of the binary codeword.

7. The method of claim 5, further comprising aggregating bypass bins from the current depth block together for the bypass coding, wherein the bypass bins correspond to one or more bypass coded bins of one or more codewords associated with the current depth block and the bypass bins include the rest bins of the binary codewords.

8. A method of depth coding for a depth block in a three-dimensional (3D) encoding system or a 3D decoding system, the method comprising:
receiving input data associated with a current depth block, wherein the current depth block is coded using a depth coding mode selected from a first group consisting of an Intra SDC (Segment-wise Depth Coding) mode, DMM (Depth Modeling Mode) mode and an Inter SDC mode; and
encoding or decoding first flags associated with the current block using bypass coding, wherein the first flags corresponds to two or more members selected from a second group consisting of a first syntax element to indicate whether there is at least one residual or delta DC (Direct Current) signal for the current depth block when the current depth block is coded in the Intra SDC mode or the DMM mode, a second syntax element to indicate whether the current depth block is coded in the Inter SDC mode, a third syntax element to indicate Intra residual sign of the current block when the current depth block is coded in the Intra SDC mode or the DMM mode and there is any residual or delta DC signal for the current depth block, and a fourth syntax element to indicate Inter SDC residual sign of the current block when the current depth block is coded in the Inter SDC mode.
